(19) United States
(12) Patent Application Publication
(10) Pub. No.: US 2011/0289094 A1
(43) Pub. Date: Nov. 24, 2011

(54) INTEGRATING MEDIA CONTENT DATABASES

(75) Inventor: James R. Fisher, Collinsville, OK (US)

(73) Assignee: ROVI TECHNOLOGIES CORPORATION, Santa Clara, CA (US)

(21) Appl. No.: 12/875,469

(22) Filed: Sep. 3, 2010

Related U.S. Application Data
(60) Provisional application No. 61/346,030, filed on May 18, 2010.
(60) Provisional application No. 61/345,813, filed on May 18, 2010.
(60) Provisional application No. 61/345,877, filed on May 18, 2010.

(51) Int. Cl. G06F 17/30

(52) U.S. Cl. 707/748; 707/736; 707/E17.104

(57) ABSTRACT

Media content databases are integrated by comparing metadata from records and determining that the metadata are a match based on the comparison. Alphanumeric strings are generated and assigned to the metadata, and the alphanumeric strings and fields of the records are stored in a data structure.

### CROSS-REFERENCE TO RELATED APPLICATIONS

This application claims priority to U.S. Provisional Patent Application Nos. 61/345,813, 61/345,877, and 61/346,030, all filed May 18, 2010, the content of each of which is hereby incorporated by reference in its entirety, as if set forth fully herein.

### BACKGROUND

1. Technical Field

Example aspects of the invention generally relate to data integration, and more particularly to matching data objects from multiple datasets according to comparisons of the objects' attributes.

2. Background Art

Data integration, also known as “data matching,” is the procedure of combining data elements from multiple datasets into a single master data representation. Data integration of datasets is typically accomplished by comparing the individual data elements of the datasets to each other for matches. These matches are used to determine which elements are contained in more than one dataset.

Data integration is often performed to address “information siloing,” which is a problem that arises when an enterprise accesses and uses information contained in datasets that were generated in isolation from each other. This can occur, for example, when information is contained in isolated datasets generated by various divisions of the enterprise or by third parties. The discrete, isolated datasets are referred to as “silos.” In such instances, the datasets may represent data elements in different ways, making it difficult for the enterprise to identify redundant or matching data elements efficiently.

One goal of data integration is to provide an enterprise with access to a consolidated dataset having a uniform data representation. Having a consolidated dataset improves data retrieval accuracy and data access times.

Typical data integration platforms integrate datasets through the use of logical algorithms that identify common or similar attributes of various data elements. Commercial algorithms used by these platforms often incorporate fuzzy logic to improve match results, and many allow users to customize rules that are embodied by the algorithms.

Despite the development and use of these data integration platforms, problems remain for enterprises that choose to undertake data integration. For one, the degree of customization allowed in commercial algorithms may not be sufficient to provide accurate match results during a matching procedure involving specialized data or data types. This can complicate consolidation.

Moreover, even where an enterprise successfully consolidates its data, it may have customers, affiliates, or partners who need or choose to access an original dataset rather than the consolidated dataset. Efficiency demands that the enterprise be able to quickly relate or convert data elements between the two.

### SUMMARY

Example embodiments of the invention described herein meet the above-identified needs by providing methods, systems and computer-readable media for integrating media content databases.

One example aspect provides a method for integrating media content databases. The method includes receiving first metadata from a record stored in a first media content database, receiving second metadata from a record stored in a second media content database, comparing a field of the first metadata to a field of the second metadata (the field of the first metadata and the field of the second metadata both containing media content information), determining that the media content information of the field of the first metadata contains information relating to the media content information of the field of the second metadata, generating an alphanumeric string and a data structure, assigning the alphanumeric string to the first metadata by storing in the data structure the alphanumeric string and a field of the record stored in the first media content database, and assigning the alphanumeric string to the second metadata by storing in the data structure the alphanumeric string and a field of the record stored in the second media content database.

Another example aspect provides a non-transitory computer-readable medium storing instructions. The instructions, when executed by a processor, cause the processor to perform receiving first metadata from a record stored in a first media content database, receiving second metadata from a record stored in a second media content database, comparing a field of the first metadata to a field of the second metadata (the field of the first metadata and the field of the second metadata both containing media content information), determining that the media content information of the field of the first metadata contains information relating to the media content information of the field of the second metadata, generating an alphanumeric string and a data structure, assigning the alphanumeric string to the first metadata by storing in the data structure the alphanumeric string and a field of the record stored in the first media content database, and assigning the alphanumeric string to the second metadata by storing in the data structure the alphanumeric string and a field of the record stored in the second media content database.

Yet another example aspect provides a system for integrating media content databases. The system includes a matching component and a data storage component. The matching component configured to compare metadata from two records, determine whether the two records are a match based on the comparison, and assign an alphanumeric string to the two records. The data storage component is configured to store media content databases, send metadata from records stored in the media content databases to the matching component, and store, in a data structure separate from the media content databases, the alphanumeric string and a field of each of the two records. Each of the two records is stored in a different media content database

Features, advantages, and the structure and operation of various example embodiments of the invention are discussed in the detailed description below with reference to the accompanying drawings.

### BRIEF DESCRIPTION OF THE DRAWINGS

The features of the example embodiments presented herein will become more apparent from the detailed description set forth below when taken in conjunction with the drawings.

FIG. 1 is a flow diagram of an example data matching procedure.

FIG. 2 is a block diagram of modules that may be configured to operate in accordance with the procedure of FIG. 1.

FIG. 3 illustrates a graphical representation of an example of a cluster.

FIG. 4 illustrates examples of a cluster and a grouping.

FIG. 5 illustrates a graphical representation of an example of a grouping.

FIG. 6 is an illustration of a use of a consolidated data structure.

FIG. 7 is a ladder diagram illustrating an example procedure for integrating media content databases.

FIG. 8 illustrates an example architecture of a data matching system.

FIG. 9 is a block diagram of a computer for use with various example embodiments of the invention.

### DETAILED DESCRIPTION

### I. Definitions

Some terms are defined below for easy reference. However, it should be understood that the defined terms are not rigidly restricted to their definitions. A term may be further defined by its use in other sections of this description.

“Album” means a collection of tracks. An album is typically originally published by an established entity, such as a record label (e.g., a recording company such as Warner Brothers and Universal Music).

“Blu-ray” and “Blu-ray Disc” mean a disc format jointly developed by the Blu-ray Disc Association, and personal computer and media manufacturers including Apple, Dell, Hitachi, HP, JVC, LG, Mitsubishi, Panasonic, Pioneer, Philips, Samsung, Sharp, Sony, TDK and Thomson. The format was developed to enable recording, rewriting and playback of high-definition (HD) video, as well as storing large amounts of data. The format offers more than five times the storage capacity of conventional DVDs and can hold 25 GB on a single-layer disc and 800 GB on a 20-layer disc. More layers and more storage capacity may be feasible as well. This extra capacity combined with the use of advanced audio and/or video codecs offers consumers an unprecedented HD experience. While current disc technologies, such as CD and DVD, rely on a red laser to read and write data, the Blu-ray format uses a blue-violet laser instead, hence the name Blu-ray. The benefit of using a blue-violet laser (about 405 nm) is that it has a shorter wavelength than a red or infrared laser (about 650-780 nm). A shorter wavelength makes it possible to focus the laser spot with greater precision. This added precision allows data to be packed more tightly and stored in less space. Thus, it is possible to fit substantially more data on a Blu-ray Disc even though a Blu-ray Disc may have substantially similar physical dimensions as a traditional CD or DVD.

“Chapter” means an audio and/or video data block on a disc, such as a Blu-ray Disc, a CD or a DVD. A chapter stores at least a portion of an audio and/or video recording.

“Compact Disc” (CD) means a disc used to store digital data. The CD was originally developed for storing digital audio. Standard CDs have a diameter of 740 mm and can typically hold up to 80 minutes of audio. There is also the mini-CD, with diameters ranging from 60 to 80 mm Mini-CDs are sometimes used for CD singles and typically store up to 24 minutes of audio. CD technology has been adapted and expanded to include without limitation data storage CD-ROM, write-once audio and data storage CD-R, rewritable media CD-RW, Super Audio CD (SACD), Video Compact Discs (VCD), Super Video Compact Discs (SVCD), Photo CD, Picture CD, Compact Disc Interactive (CD-i), and Enhanced CD. The wavelength used by standard CD lasers is about 650-780 nm, and thus the light of a standard CD laser typically has a red color.

“Consumer,” “data consumer,” and the like, mean a consumer, user, client, and/or client device in a marketplace of products and/or services.

“Content,” “media content,” “content data,” “multimedia content,” “program,” “multimedia program,” and the like are generally understood to include music albums, television shows, movies, games, videos, and broadcasts of various types. Similarly, “content data” refers to the data that includes content. Content (in the form of content data) may be stored on, for example, a Blu-Ray Disc, Compact Disc, Digital Video Disc, floppy disk, mini disk, optical disc, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of storage device.

“Content information,” “content metadata,” and the like refer to data that describes content and/or provides information about content. Content information may be stored in the same (or neighboring) physical location as content (e.g., as metadata on a music CD or streamed with streaming video) or it may be stored separately.

“Data correlation,” “data matching,” “matching,” and the like refer to procedures by which data may be compared to other data.

“Data object,” “data element,” “dataset,” and the like refer to data that may be stored or processed. A data object may be composed of one or more attributes (“data attributes”). A table, a database record, and a data structure are examples of data objects.

“Database” means a collection of data organized in such a way that a computer program may quickly select desired pieces of the data. A database is an electronic filing system. In some implementations, the term “database” may be used as shorthand for “database management system.”

“Data structure” means data stored in a computer-usable form. Examples of data structures include numbers, characters, strings, records, arrays, matrices, lists, objects, containers, trees, maps, buffer, queues, matrices, look-up tables, hash lists, booleans, references, graphs, and the like.

“Device” means software, hardware, or a combination thereof. A device may sometimes be referred to as an apparatus. Examples of a device include without limitation a software application such as Microsoft Word™, a laptop computer, a database, a server, a display, a computer mouse, and a hard disk.

“Digital Video Disc” (DVD) means a disc used to store digital data. The DVD was originally developed for storing digital video and digital audio data. Most DVDs have substantially similar physical dimensions as compact discs (CDs), but DVDs store more than six times as much data. There is also the mini-DVD, with diameters ranging from 60 to 80 mm DVD technology has been adapted and expanded to include DVD-ROM, DVD-R, DVD+R, DVD-RW, DVD+RW and DVD-RAM. The wavelength used by standard DVD lasers is about 605-650 nm, and thus the light of a standard DVD laser typically has a red color.

“Fuzzy search,” “fuzzy string search,” and “approximate string search” mean a search for text strings that approximately or substantially match a given text string pattern. Fuzzy searching may also be known as approximate or inexact matching. An exact match may inadvertently occur while performing a fuzzy search.

“Link” means an association with an object or an element in memory. A link is typically a pointer. A pointer is a variable that contains the address of a location in memory. The location is the starting point of an allocated object, such as an object or value type, or the element of an array. The memory may be located on a database or a database system. “Linking” means associating with, or pointing to, an object in memory.

“Metadata” means data that describes data. More particularly, metadata may be used to describe the contents of recordings. Such metadata may include, for example, a track name, a song name, artist information (e.g., name, birth date, discography), album information (e.g., album title, review, track listing, sound samples), relational information (e.g., similar artists and albums, genre) and/or other types of supplemental information such as advertisements, links or programs (e.g., software applications), and related images. Other examples of metadata are described herein. Metadata may also include a program guide listing of the songs or other audio content associated with multimedia content. Conventional optical discs (e.g., CDs, DVDs, Blu-ray Discs) do not typically contain metadata. Metadata may be associated with a recording (e.g., a song, an album, a video game, a movie, a video, or a broadcast such as a radio, television or Internet broadcast) after the recording has been ripped from an optical disc, converted to another digital audio format and stored on a hard drive. Metadata may be stored together with, or separately from, the underlying data that is described by the metadata.

“Network” means a connection between any two or more computers, which permits the transmission of data. A network may be any combination of networks, including without limitation the Internet, a network of networks, a local area network (e.g. home network, intranet), a wide area network, a wireless network, and a cellular network.

“Occurrence” means a copy of a recording. An occurrence is preferably an exact copy of a recording. For example, different occurrences of a same pressing are typically exact copies. However, an occurrence is not necessarily an exact copy of a recording, and may be a substantially similar copy. A recording may be an inexact copy for a number of reasons, including without limitation an imperfection in the copying process, different pressings having different settings, different copies having different encodings, and other reasons. Accordingly, a recording may be the source of multiple occurrences that may be exact copies or substantially similar copies. Different occurrences may be located on different devices, including without limitation different user devices, different MP3 players, different databases, different laptops, and so on. Each occurrence of a recording may be located on any appropriate storage medium, including without limitation floppy disk, mini disk, optical disc, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of storage device. Occurrences may be compiled, such as in a database or in a listing.

“Pressing” (e.g., “disc pressing”) means producing a disc in a disc press from a master. The disc press preferably produces a disc for a reader that utilizes a laser beam having a wavelength of about 650-780 nm for CD, about 605-650 nm for DVD, about 405 nm for Blu-ray Disc or another wavelength as may be appropriate.

“Program,” “multimedia program,” “show,” and the like include video content, audio content, applications, animations, and the like. Video content includes television programs, movies, video recordings, and the like. Audio content includes music, audio recordings, podcasts, radio programs, spoken audio, and the like. Applications include code, scripts, widgets, games and the like. The terms “program,” “multimedia program,” and “show” include scheduled content (e.g., broadcast content and multicast content) and unscheduled content (e.g., on-demand content, pay-per-view content, downloaded content, streamed content, and stored content).

“Recording” means media data for playback. A recording is preferably a computer readable recording and may be, for example, a program, a music album, a television show, a movie, a game, a video, a broadcast of various types, an audio track, a video track, a song, a chapter, a CD recording, a DVD recording and/or a Blu-ray Disc recording, among other things.

“Server” means a software application that provides services to other computer programs (and their users), in the same or another computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Signature” means an identifying means that uniquely identifies an item, such as, for example, a track, a song, an album, a CD, a DVD and/or Blu-ray Disc, among other items. Examples of a signature include without limitation the following in a computer-readable format: an audio fingerprint, a portion of an audio fingerprint, a signature derived from an audio fingerprint, an audio signature, a video signature, a disc signature, a CD signature, a DVD signature, a Blu-ray Disc signature, a media signature, a high definition media signature, a human fingerprint, a human footprint, an animal fingerprint, an animal footprint, a handwritten signature, an eye print, a biometric signature, a retinal signature, a retinal scan, a DNA signature, a DNA profile, a genetic signature and/or a genetic profile, among other signatures. A signature may be any computer-readable string of characters that comports with any coding standard in any language. Examples of a coding standard include without limitation alphabet, alphanumeric, decimal, hexadecimal, binary, American Standard Code for Information Interchange (ASCII), Unicode and/or Universal Character Set (UCS). Certain signatures may not initially be computer-readable. For example, latent human fingerprints may be printed on a door knob in the physical world. A signature that is initially not computer-readable may be converted into a computer-readable signature by using any appropriate conversion technique. For example, a conversion technique for converting a latent human fingerprint into a computer-readable signature may include a ridge characteristics analysis.

“Software” and “application” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++, and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“Song” means a musical composition. A song is typically recorded onto a track by a record label (e.g., recording company). A song may have many different versions, for example, a radio version and an extended version.

“System” means a device or multiple coupled devices. A device is defined above.

“Theme song” means any audio content that is a portion of a multimedia program, such as a television program, and that recurs across multiple occurrences, or episodes, of the multimedia program. A theme song may be a signature tune, song, and/or other audio content, and may include music, lyrics, and/or sound effects. A theme song may occur at any time during the multimedia program transmission, but typically plays during a title sequence and/or during the end credits.

“Track” means an audio/video data block. A track may be on a disc, such as, for example, a Blu-ray Disc, a CD or a DVD.

“User device” (e.g., “client”, “client device”, “user computer”) is a hardware system, a software operating system and/or one or more software application programs. A user device may refer to a single computer or to a network of interacting computers. A user device may be the client part of a client-server architecture. A user device typically relies on a server to perform some operations. Examples of a user device include without limitation a television (TV), a CD player, a DVD player, a Blu-ray Disc player, a personal media device, a portable media player, an iPod™, a Zoom Player, a laptop computer, a palmtop computer, a smart phone, a cell phone, a mobile phone, an MP3 player, a digital audio recorder, a digital video recorder (DVR), a set top box (STB), a network attached storage (NAS) device, a gaming device, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Web browser” means any software program which can display text, graphics, or both, from Web pages on Web sites. Examples of a Web browser include without limitation Mozilla Firefox™ and Microsoft Internet Explorer™.

“Web page” means any documents written in a mark-up language including without limitation HTML (hypertext mark-up language) or VRML (virtual reality modeling language), dynamic HTML, XML (extensible mark-up language) or related computer languages thereof, as well as to any collection of such documents reachable through one specific Internet address or at one specific Web site, or any document obtainable through a particular URL (Uniform Resource Locator).

“Web server” refers to a computer or other electronic device which is capable of serving at least one Web page to a Web browser. An example of a Web server is a Yahoo™ Web server.

“Web site” means at least one Web page, and more commonly a plurality of Web pages, virtually coupled to form a coherent group.

### II. Data Matching Procedure

Generally, data integration of multiple datasets is performed by comparing data objects from one or more of the datasets. The comparison is made according to algorithms and predetermined rules established to identify matches among data objects. These matches are used to define clusters of data objects and to define groupings of clustered and/or unclustered objects.

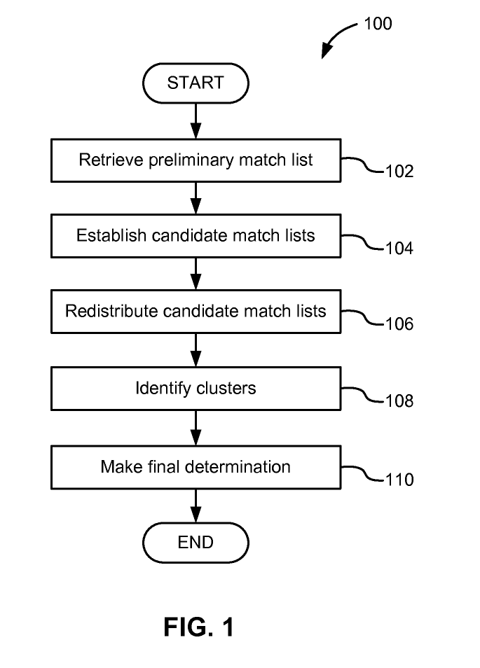

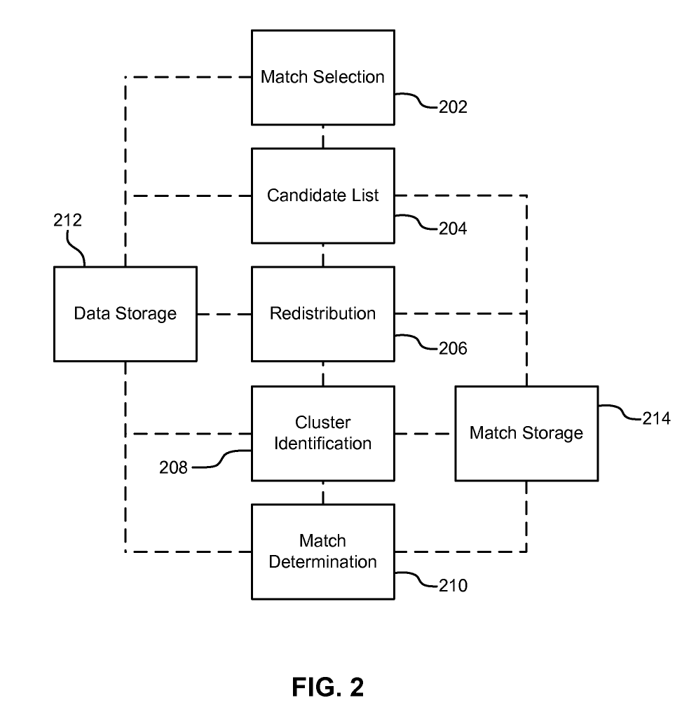

An example procedure for identifying matches among data objects is described with reference to FIG. 1, and a diagram of example modules configured to be operable in accordance with the procedure is shown in FIG. 2. It should be understood that connections shown in FIGS. 1 and 2 are simply examples. The blocks shown in FIG. 1, for example, need not be performed in the order presented. Similarly, the modules shown in FIG. 2 may be communicatively coupled in alternative ways. In addition, the connections shown in FIG. 2 may be physical or logical connections, depending on the implementation.

### A. Fuzzy Matching

With reference to FIGS. 1 and 2, at block 102, a preliminary match list is retrieved from a match selection module 202 by a candidate list module 204. The preliminary match list is used by the candidate list module 204 to generate other lists of matches called “candidate matches” which, in turn, are used to determine clusters and solitary matches, as discussed below. The match selection module 202 generates the preliminary match list prior to or during any stage of the match procedure 100. Particularly, the match selection module 202 generates the preliminary match list from sets of data objects retrieved from a data storage module 212.

In one example embodiment, the match selection module 202 compares a target data object, such as an unmatched data object that belongs to a particular dataset, to other data objects belonging to other datasets. The match selection module 202 matches the target data object to the other data objects by examining their attributes for similarities, for example, by using a fuzzy matching procedure.

The preliminary match list includes any data objects identified as potentially matching the target data object as well as corresponding numeric weights that indicate the likelihood of a match between each of the identified data objects and the target data object. A higher value of the numeric weight indicates a greater similarity and likelihood of a match, and vice versa. As is described in more detail below, the preliminary match list is a basis for determining further matches in the matching procedure.

An example fuzzy matching procedure is now described. As explained above, match selection module 202 generates a preliminary match list by finding similarities between a target data object and other data objects based on a comparison of data contained in the data objects' attributes. Examples of data object attributes include text, audio/video data, machine-readable code, and the like. Where data objects are database records, the attributes include the fields of the records. As the match selection module 202 compares the target data object attributes with the attributes of other data objects, it associates a numeric weight to each similar pair based on the closeness of the attributes. The weight may be determined by the module's stored weighting functions. For example, when evaluating database records, a lack of shared keywords in one field of the records may cause the module to decrease the numeric weight by 2%, while a similarity in another field of the records may cause the module to increase the numeric weight by a greater percentage.

### B. Candidate List Matching

At block 104, the candidate list module 204 establishes candidate lists of matches based on the preliminary match list. Generally, matches contained in the preliminary match list are divided based on their numerical weight values and sorted into candidate lists.

Each numerical weight that separates one candidate list from another is a threshold value. Threshold values may be predetermined (e.g., determined by the enterprise performing the data integration or by a third party such as a data consumer) or arbitrary (e.g., generated by a manual or automatic procedure using software or hardware). Threshold values may be determined by empirical or statistical considerations (e.g., generated by trial and error experimentation or information from knowledge experts in the field of matching data objects). For example, an interface may be used to input information from knowledge experts to the candidate list module 204, thereby generating the threshold values.

The threshold values are stored in the candidate list module 204 or in the data storage module 212 and retrieved by the candidate list module 204 prior to or at block 104, as explained above.

Matches on the preliminary match list having a weight less than a particular threshold value are deemed weaker matches than matches having a weight higher than that threshold value. Accordingly, each threshold value is a demarcation between a candidate list of stronger matches and a candidate list of weaker matches. The number of candidate lists generated by the candidate list module 204 thus depends on the number of threshold values. The candidate list module 204 may store one or more candidate lists in the data storage module 212 or a match storage module 214.

Optionally, block 104 includes discarding certain candidate lists. For example, candidate lists having low match weights are discarded, thus eliminating the matches contained on those lists from further consideration at other blocks of the matching procedure. Discarding candidate lists having low match weights reduces the number of preliminary matches considered for final match determination, improving the processing time of, and resources required by, the data matching procedure. Discarding also can reduce the occurrence of spurious incorrect matches.

Block 104 is further described by way of the following example. A preliminary match list is retrieved at block 102 from the match selection module 202. The preliminary match list contains matches having numeric weights ranging from 0 to 1. Division of those matches into candidate lists at block 104 is made according to two threshold values t₁=0.90 and t₂=0.75. The weighted matches are placed by the candidate list module 204 onto three lists L1, L2, and L3. All preliminary list matches having values between 1 and 0.90, the first threshold value, are in list L1. All matches between 0.90 and 0.75, the second threshold value, are in list L2. And all matches from 0.75 to 0 are in list L3. List L1 contains the highest-weighted matches, while list L3 contains the lowest-weighted matches. As block 104 further may include discarding low-weight candidate lists, list L3 may be discarded, for example.

In an example embodiment, three candidate match lists are established from the preliminary match list. These lists are a high-confidence list, a medium-confidence list, and a low-confidence list. The matches on the high-confidence list are those that have the highest likelihood, as determined by the preliminary matching procedure, while those on the low-confidence list have the lowest likelihood. In this embodiment, the matches on the high- and medium-confidence lists are retained for further processing at block 106, while the low-confidence list is discarded.

The candidate lists of matches are redistributed by a redistribution module 206 at block 106. Redistribution is performed by applying enterprise-specific predetermined rules to the candidate lists. Generally, predetermined rules are application- and/or enterprise-defined logic for determining whether a match exists. The application of predetermined rules at block 106 differs from the fuzzy matching procedure used to generate the preliminary match list. While both predetermined rules and fuzzy matching determine the likelihood of a match, the basis on which likelihood is determined by fuzzy matching differs from the basis of the predetermined rules, as discussed below.

Input for redistribution at block 106 includes the matches from the candidate lists established at block 104. Input for redistribution may further include information relating to the target data object and/or the data objects on the candidate lists such as the dataset from which a particular data object originates.

### C. Procedures Operating on Data Objects

Generally, multiple predetermined rules are applied at block 106 by redistribution module 206. The predetermined rules include procedures that match data object attributes, procedures that compare data object attributes, and procedures that evaluate similarities and differences between related data object attributes. For example, a target data object and data objects on the candidate lists may be database records that originate from media content databases (e.g., multimedia and entertainment content databases). In this instance, the predetermined rules may match, evaluate, or compare information from data attributes such as, for example, title, release year, program type, rating, keywords, language, origin, episode number, episode name, season number, and credits.

The predetermined rules applied at block 106 may vary. For example, whether a particular predetermined rule is used may depend on the dataset from which a target data object originates or on the dataset from which a data object on a candidate list originates. In this example, one set of predetermined rules may be applied when the target data object originates from a particular dataset, while another set may be applied when the target data object originates from another dataset.

The calculation of a particular predetermined rule, such as matching, comparing, or evaluating performed by that rule, also may vary. For example, the calculation of a predetermined rule may depend on the dataset from which a target data object originates or on a dataset from which a data object on a candidate lists originates. In this example, where a dataset of a particular data object is known to have accurate information for a certain data attribute, a predetermined rule may assign a greater weight to calculations that relate to that data attribute. Conversely, where a dataset is known to have unreliable or inconsistent information for a particular data attribute, a predetermined rule may assign little or no weight to calculations that relate to that attribute. As other examples, the calculation of a predetermined rule also may vary depending on the threshold values used to divide the candidate lists, the numeric weight of a particular match on a candidate list, and the kind of data objects being matched.

In an example embodiment, the predetermined rules are adjusted during redistribution. The predetermined rules are modified, enabled, or disabled by data-driven procedures, e.g., the application of the predetermined rules to one match may be used to adjust the application of the predetermined rules to a later match. The adjustment of the predetermined rules may be made automatically or manually. The predetermined rules may be adjusted based on information retrieved by the redistribution module 206 from the data storage module 212 or the match storage module 214.

Redistribution uses the results from the predetermined rules to modify the weights of the matches on the candidate lists. For example, the redistribution module 206 may apply the predetermined rules and determine that a particular match on a high-confidence candidate list is less likely than its numeric weight indicates. Accordingly, the weight of the match is decreased, which may move the match onto a candidate list of lower confidence. Conversely, the redistribution module 206 may determine that a particular match on a low-confidence candidate list is more likely and increase the weight of the match, which may move it onto a higher-confidence candidate list.

Redistribution may include revising the threshold values dividing the candidate lists. Redistribution further may include adding additional threshold values or deleting threshold values, thereby increasing or decreasing the number of candidate lists.

### D. Cluster Identification

At block 108, cluster identification is performed by a cluster identification module 208 based on the redistributed candidate lists. Matches between the target data object and data objects on the candidate lists are compared to known matches between the data objects on the candidate lists. The cluster identification module 208 retrieves known matches from the match storage module 214. Where there are matches between the target data object and matches between data objects on the candidate lists, the target data object and the matching data objects collectively may be deemed to be the same data object, and those data objects may be identified as a cluster.

While logic used to identify clusters may vary, in an example embodiment, clusters are identified based on data objects that remain on the highest-confidence list after redistribution. Specifically, if any of the data objects on the highest-confidence list are known to match to each other, then the target data object and the matching data objects on the list are identified collectively as a cluster.

For example, if the target data object is matched to two objects on the highest-confidence list, and those two objects have been identified as matching each other, then all three objects are identified as the same object, and the matches among the three objects are identified as a cluster. In other example embodiments, cluster identification may proceed according to different logic, including identifying clusters among matches between data objects on lesser-confidence lists. For example, where the data objects are database records that originate from various media content databases, cluster identification may use logic that determines whether the target record and any other records originate from the same database. This logic may be used, for example, when it is known that no two records in a database are the same. Thus, there should not be a cluster containing multiple records from the same database, and any matches between the target record and a record in the same database as the target record are erroneous and should be discarded.

Various features of clusters and additional examples are provided below.

### E. Final Determination of Clusters and Solitary Matches

At block 110, final determinations of clusters (e.g., matches between three or more data objects) and solitary matches (e.g., matches between two data objects) are made by a match determination module 210. Determinations made by the match determination module 210 are based on the redistributed candidate lists and any clusters identified at block 108. Solitary matches and clusters determined by the match determination module 210 are permanently stored by the match storage module 214. In an example embodiment, clusters are stored in a table structure, as discussed in detail in connection with Table 1 below.

A final determination includes one or more of the following rules: any cluster identified at block 108 may be determined to be a cluster for storage; if after block 106 the highest-confidence list contains a single data object and no cluster is identified at block 108, then the target data object and the single data object may be determined to be a solitary match; and if after block 106 there are no data objects on the highest-confidence list (e.g., there are no matches above the highest threshold value) and no cluster is identified at block 108, then the target data object remains unmatched and is returned to data storage module 212, from which matching of this object may be attempted again in a subsequent data matching procedure.

Block 110 optionally may include a final determination of one or more candidate matches. Candidate matches are matches that may be likely based upon the redistribution of the candidate lists, yet are deemed not sufficiently certain to be stored as solitary matches or clusters. Candidate matches include candidate solitary matches and candidate clusters. Moreover, candidate matches are not limited to being between unmatched data objects. Rather, candidate matches can be made to previously-determined solitary matches and clusters that have been stored in match storage module 214. For example, an unmatched data object may be a candidate match to a solitary match, or a solitary match may be a candidate match to a cluster.

Candidate matches determined at block 110 should be distinguished from the candidate lists established at block 104 and redistributed at block 106. Instead of being stored permanently, candidate matches are stored temporarily for further processing, such as a later automatic determination of a match in a subsequent data matching procedure or a manual determination of a match by the enterprise or a third party. For example, if there is no match to the target data object above the highest-confidence threshold but there are matches in other candidate lists, these matches may be determined to be candidate matches and stored in match storage module 214 for further processing.

The contours of the data integration procedures described herein are simply examples. Those having skill in the art will recognize that they may be modified in various ways as the needs or resources of an enterprise dictate. For example, while the example procedure described above includes identifying clusters, it is contemplated that other procedures also may include identifying groupings, as described below, or may omit cluster identification. Similarly, while the example procedure includes retrieving a preliminary match list, other procedures may forgo such retrieval.

### III. Data Structures for Storing Data Object Matches

### A. Cluster Definition

Matches between data objects may be stored in a data structure that supports such matches. This data structure is termed a “cluster.” A cluster is used to describe a set of data objects determined by a data matching procedure to be the same data object, despite any differences that may exist among the data objects' individual attributes. Examples of data matching procedures that make such determinations have been described above.

A cluster is defined as the set of data elements which records all assignments of a common “cluster identifier” to each data object in a set of matching data objects. The cluster identifier can be an alphanumeric string and it is unique to a particular cluster. A cluster thus is generated by assigning a cluster identifier to each matching data object and recording the assignments.

An alphanumeric string, as used herein, refers to a sequence of one or more characters, including integers, letters, symbols, and/or combinations thereof. In an example embodiment, each cluster identifier is an alphanumeric string of numbers, such that each cluster identifier is an integer.

A cluster need not record each match between individual data objects, e.g., it need not record object-to-object matches.

Clusters may be stored by the enterprise for later retrieval or modification during subsequent data matching procedures. Data consumers may retrieve clusters. This may involve formatting the cluster data into a different form, such as a record of each individual match.

### B. An Example Cluster

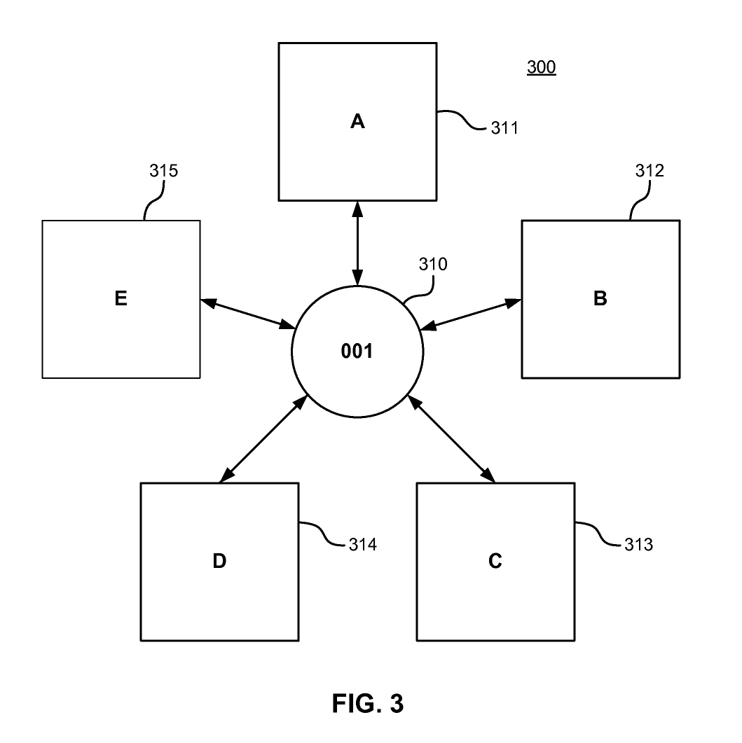

Differences between a cluster and object-to-object matches may be further shown by way of example. Consider a set of five data objects A, B, C, D, and E. Assume that each of these data objects is found to match the others. Storing these matches individually in object-to-object form requires storing a record of each direct correlation. This requires ten data elements: A-B, A-C, A-D, A-E, B-C, B-D, B-E, C-D, C-E, and E-D. Alternatively, however, a cluster may be used to store the matches. FIG. 3 shows a graphical representation of such a cluster 300. To establish the cluster 300, a unique identifier 310 is defined and assigned to each of the five data objects 311, 312, 313, 314, and 315. To record the matches, the cluster 300 requires only five data elements, each of which records the assignment of the unique identifier 310 to one of the data objects, as illustrated by each two-way arrow in FIG. 3. The cluster identifier unique to this cluster is 001, as shown in the figure. The data elements required to store the matches thus are A-001, B-001, C-001, D-001, and E-001. Therefore, the cluster 300 is the data structure containing the five data elements A-001, B-001, C-001, D-001, and E-001.

### C. Differences Between Clusters and Object-to-Object Matches

Clustering, as described above, involves storing matches between data objects by a cluster identifier. This differs in several ways from storing each object-to-object match individually. For one, less storage space may be needed to store matches. For a set of n matching data objects, storing the matches individually requires

$$\frac{n ( n - 1 )}{2}$$

data elements, while storing the matches in a cluster requires only n data elements. Furthermore, the reduced number of data elements associated with match storage may improve maintenance of stored matches. For example, in the event that one data object in a set of matching data objects is later determined to not match to the rest of the data objects in the set, removing the mismatched data object's matches may be done by deleting the single data element which records the assignment of the cluster's unique identifier to the mismatched data object. Were the matches stored in object-to-object form, every data element recording a match of the mismatched data object would have to be found and deleted. A cluster also improves maintenance of stored matches. For example, adding an unclustered data object to a stored cluster requires only the addition of a data element recording that data object's assignment of the cluster identifier; the data object easily inherits the previously stored matches recorded by the cluster.

### D. Variations

As explained above, matches between data objects may be stored according to cluster identifiers, such that each matched data object is assigned a cluster identifier and each assignment is stored in a cluster. However, in some example embodiments, match storage may include other mechanisms in which object-to-object matches are stored as separate data elements. Similarly, other mechanisms for generating object-to-object matches from a cluster's data elements may be implemented. For example, a data consumer may request that the matches recorded by a particular cluster be retrieved in a form that shows each individual match between data objects, or a system performing a data matching procedure may require that object-to-object matches be retrieved as input data. In these instances, a cluster may be modified or otherwise operated on in order to generate object-to-object matches. Accordingly, the storage of matches in a cluster does not limit the ways in which matches may be internally or externally presented to, for example, the enterprise, a data consumer, or a system performing a data matching procedure.

### IV. Groupings

### A. Approximate Matches

Relationships between multiple clusters of data objects and unmatched data objects may be determined by a data matching procedure. Referring back to the example data matching procedure of FIG. 1, that procedure was described with reference to a target data object. Generally, the procedure matched a single data object, such as a database record, to other data objects. The procedure used candidate lists of matches and predetermined rules to determine clusters and solitary matches.

However, in example embodiments, a data matching procedure is not limited to matching a single target data object. Rather, a data matching procedure further determines whether a cluster relates to other clusters and/or data objects. In this manner, data relationships between clusters of matched data objects may be established. Such data relationships are different from those established by clustering.

While a cluster provides a way to store multiple matches among data objects, it may not support what is described herein as an “approximate match.” An approximate match is a data relationship between data objects indicating a degree of similarity between the data objects. However, where two data objects approximately match, they are determined to not match each other. Accordingly, an approximate match cannot be recorded in a cluster because a cluster identifier may be assigned only to data objects that are determined to be the same data object.

One cluster approximately matches another cluster when the data objects of the one cluster approximately match the data objects of the other cluster.

### B. Procedure for Determining Groupings

Example embodiments allow approximate matches between clusters to be stored and maintained by using “groupings,” as discussed below.

A data matching procedure for approximately matching clusters of data objects proceeds generally in a manner similar to the data matching procedure of FIG. 1. Accordingly, only a brief discussion of such a matching procedure is necessary to provide to those having skill in the art an understanding of how to modify or use the procedure of FIG. 1 to enable cluster matching.

Generally, a target cluster is approximately matched to another cluster by comparing the attributes of at least one of the data objects of the target cluster to the attributes of at least one of the data objects of the other cluster and determining whether the data objects of the target cluster approximately match the data objects of the other cluster. Additionally, a cluster may be approximately matched to an unclustered data object, e.g., a data object that has not be determined to match to another data object, and vice versa, by comparing the attributes of at least one of the data objects of the cluster to the attributes of the unclustered data object and determining whether the data objects of the cluster approximately match the individual data object.

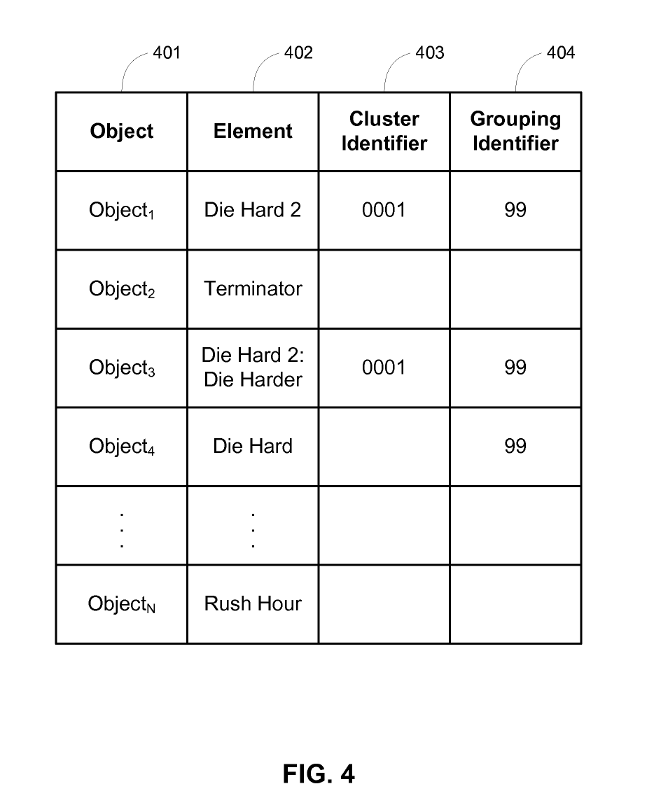

A preliminary match list based on fuzzy logic is retrieved. The preliminary match list includes any clusters identified as potentially approximately matching the target cluster. Candidate lists of cluster matches are generated and redistributed based on predetermined rules. Following redistribution, approximate matches between clusters are identified as “groupings,” as discussed in detail below. A final match determination stores identified groupings and candidate groupings. In an example embodiment, groupings (and/or candidate groupings) are stored in a table structure, as discussed in detail in connection with FIG. 4 and Table 1 below.

### V. Data Structures for Storing Cluster Matches

### A. Grouping Definition

Approximate matches between clusters and/or data objects may be stored in a data structure referred to herein as a grouping. A grouping is used to describe a set of clusters and/or data objects determined by a data matching procedure to approximately match each other, e.g., to have some degree of similarity yet not be the same data object.

A grouping is defined as the set of data elements which records all assignments of a common “grouping identifier” to each data object in a set of approximately matching clusters and data objects. The grouping identifier can be an alphanumeric string, e.g., a numeric value, and it is unique to a particular grouping. A grouping thus is generated by assigning the grouping identifier to every approximately matching data object, whether clustered or unclustered, and recording the assignments.

A grouping is similar in function to a cluster. Both are used to record matches and, like a cluster, a grouping does not record each approximate match between individual data objects, e.g., it does not record object-to-object approximate matches.

As discussed above, a data matching procedure may be used to identify approximate matches among clusters and/or data objects, e.g., the procedure may identify a relationship indicating sufficient similarity between those clusters and objects. In one embodiment, whether one cluster (or data object) is determined to approximately match another may depend on predetermined rules such as those that an enterprise applies in a data matching procedure.

A grouping is generated by assigning a grouping identifier to approximately matching clusters and unclustered data objects. The assignments are then stored, and the set of data elements that records the assignments is the grouping.

Groupings may be stored by the enterprise for later retrieval or modification during subsequent data matching procedures. Groupings also may be retrieved by data consumers. This may involve formatting the grouping data into a different form, such as a record of each individual approximate match between data objects in the grouping.

### B. An Example Grouping

Differences between a cluster and a grouping are now described by way of example and with reference to FIG. 4. In this example, a class of objects 401 is defined as having N data objects Object₁, Object₂, Object₃, Object₄, . . . , Object_{N}, which all are within a class of multimedia, namely, movies. Data elements 402 describing the objects' attributes (e.g., title) are, respectively, Die Hard 2, Terminator, Die Hard 2: Die Harder, Die Hard, . . . , Rush Hour.

The movie data objects are processed during a data matching procedure. Object₁ and Object₃ may be determined to be the same movie data object because their attributes are closely related titles. In particular, they are two descriptive forms of the same movie. While the titles are not exact, the predetermined rules recognize that it is not necessary for attributes of two movie data objects to be the same in order for the data matching procedure to determine that the movie data objects are the same movie data object. These objects may be assigned a cluster identifier 403. In turn, the assignments are stored in data elements that define a particular cluster.

Object₄, however, is determined as an approximate match to the cluster of Object₁ and Object₃. Although its title indicates that it is different than the movie data objects having Die Hard 2-related title attributes, its title describes a movie that has a degree of similarity to the movie of the cluster. More specifically, the movie of the cluster is a sequel to the movie of Object₄. Thus, the approximate match, which indicates a degree of similarity among the three movie data objects, may be recorded in a grouping that relates Object₄, to the cluster of Object₁ and Object₃, yet maintains a distinction between Object₄ and the cluster. The relationship is recorded by assigning a grouping identifier 404 to Object₄ and the cluster.

### C. Groupings Generally

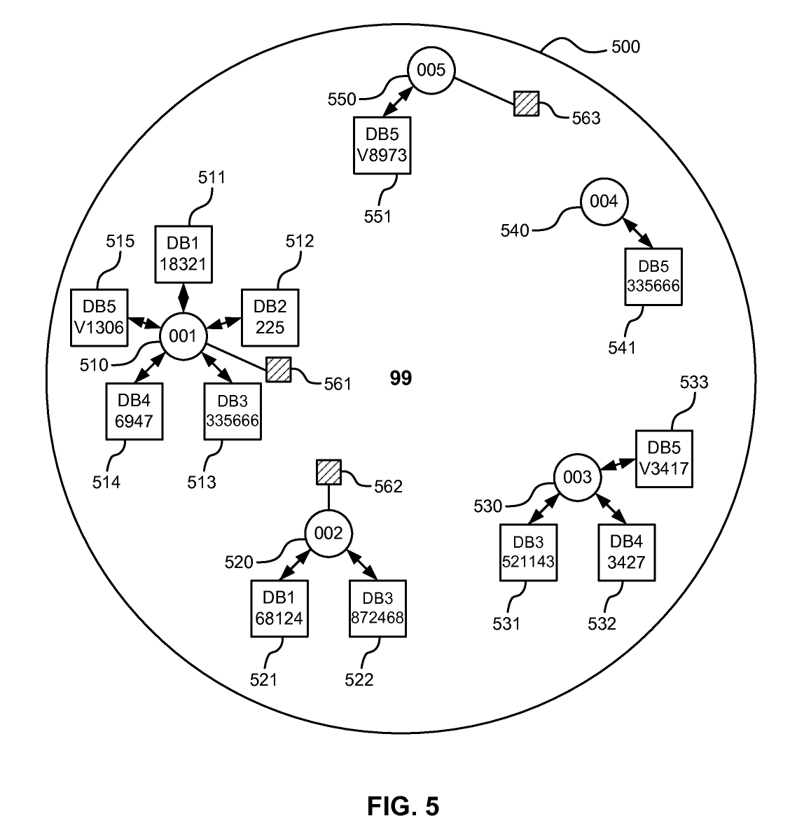

In the preceding example, the grouping consisted of a data object and a cluster. In practice, however, a grouping may consist of any combination of data objects and clusters. A grouping may be a set of only data objects, for example, if none of the data objects in the set is a match to any other data object yet each data object is an approximate match to all of the other data objects. An unclustered data object that is to be assigned a grouping identifier optionally may be further assigned its own cluster identifier. Accordingly, the determination or modification of a grouping may include the determination of one or more single-data-object clusters. This may be the case, for example, where data storage of groupings is configured such that every data object in a given grouping is assigned a cluster identifier. Single-data-object clusters are discussed in further detail below in connection with FIG. 5 and Table 1.

TABLE 1

| Grouping | Cluster | Database | Record | |
|---|---|---|---|---|
| Identifier | Identifier | Name | Number | Description |
| 99 | 001 | DB1 | 18321 | Star Wars |
| 99 | 001 | DB2 | 225 | Star Wars |
| 99 | 001 | DB3 | 335666 | Star Wars |
| 99 | 001 | DB4 | 6947 | Star Wars |
| 99 | 001 | DB5 | V1306 | Star Wars |
| 99 | 002 | DB1 | 68124 | Star Wars (Spanish) |
| 99 | 002 | DB3 | 872468 | Star Wars (Spanish) |
| 99 | 003 | DB3 | 521143 | Star Wars: Special Edition |
| 99 | 003 | DB4 | 3427 | Star Wars: Special Edition |
| 99 | 003 | DB5 | V3417 | Star Wars: Special Edition |
| 99 | 004 | DB5 | V8406 | Star Wars: Special Edition |
| | | | | (French) |
| 99 | 005 | DB5 | V8973 | Star Wars (French) |

### D. Combined Grouping and Cluster Example

FIG. 5 and Table 1 illustrate different representations of a grouping according to an example embodiment of the invention. FIG. 5 is a graphical representation of the grouping and Table 1 is a tabular representation. The data objects in this example grouping are database records. Each database record has three attributes: a database name, a record number, and a description. The data objects are database records taken from five databases having names DB1, DB2, DB3, DB4, and DB5. The record numbers are randomly assigned, except that the numbering system for each database has a consistent number of characters. The database record descriptions are variations of the movie Star Wars; the descriptions vary by release and by language. The information contained in FIG. 5 and Table 1 is similar. In FIG. 5, each database record is shown with its database name and record number. These correspond to the “Database Name” and “Record Number” columns of Table 1. However, for the sake of clarity, the records' descriptions, which are listed in the “Description” column, are not shown in FIG. 5. The grouping and cluster identifiers, which are shown at the center of the grouping and cluster elements in FIG. 5, are listed in the “Grouping Identifier” and “Cluster Identifier” columns.

Grouping 500, which is the assignment of unique grouping identifier 99 to its data object members, consists of five clusters 510, 520, 530, 540, and 550. Cluster 510 includes the five database records 511, 512, 513, 514, and 515. As shown in Table 1, these database records all have the same description: Star Wars. These database records have been determined to be matches, e.g., to all be the same database record, because their description attributes are the same. The database records are matches despite variations in their database name and record number attributes. This might occur in practice where different database compilations of the same database records have been compiled independently from each other. Thus, in this example, databases DB1, DB2, DB3, DB4, and DB5 each contain a database record for the movie Star Wars that is an exact match to a database record in the other databases. The cluster identifier for this match is 001. Cluster 520 includes records 521 and 522. Referring to Table 1, these database records also come from different databases but each describes Star Wars (Spanish), the Spanish-language version of Star Wars. Accordingly, these have been identified as a match defined by cluster identifier 002. Cluster 530 having identifier 003 includes database records 531, 532, and 533, which are records from various databases describing Star Wars: Special Edition. Clusters 540 and 550 are single-data-object clusters; cluster 540 includes database record 541, which describes Star Wars: Special Edition (French), the French-language version of Star Wars: Special Edition, and cluster 550 includes database record 551, which describes Star Wars (French), the French-language version of Star Wars.

The approximate match giving rise to grouping 500 may be described literally as the various domestic and international versions of the movie Star Wars. This approximate match, of course, was arbitrarily chosen. In practice, an approximate match is identified based on predetermined rules applied during a data matching procedure. Such identification may proceed according to predetermined rules similar to those described above in connection with block 108 of FIG. 1. Furthermore, FIG. 5 and Tables 1 and 2 are provided simply to illustrate that data objects may be assigned one cluster or another based on different matches, and that the clusters may be related together in a single grouping based on approximately matching data attributes.

Each row of Table 1 may be taken as a constituent data element of grouping 500. That is, the data elements which make up grouping 500 may correspond to the rows of the table. Objects included in the grouping are described by the columns titled “Database Name,” “Record Number,” and “Description.” In other words, these columns list each database record's data attributes. “Database Name” lists each database record's constituent database. “Record number” lists an arbitrary identification number given to each database record in its constituent database. And “Description” lists the description of each database record, as recorded in its constituent database.

### E. Table Structures for Storing Clusters and Groupings

As Table 1 illustrates, clusters and/or groupings may be stored in a table structure. Specifically, a cluster may consist of records (e.g., rows in Table 1) with a field containing a cluster identifier and at least one other field containing other information pertaining to a matched data object (e.g., a matched database record). Examples of such other information include information relating to a database from which a record originated (e.g., a provider name, a database name), a unique identifier of that record in the database (e.g., a record number and a provider identifier), and a description (or actual portion of) a matched record. Thus, a cluster in Table 1 could be a table containing the “Cluster Identifier” and “Record Number” columns Moreover, while Table 1 has a form similar in layout to a flat database, this is for ease of illustration only. For example, a cluster can be stored as records in a relational database or any other type of database.

Similarly, a grouping may consist of records with a field containing a grouping identifier and at least one other field containing other information pertaining to an approximately-matched data object. Thus, a grouping in Table 1 could be a table containing the “Grouping Identifier” and “Record Number” columns. In an example embodiment, however, a grouping consists of records with a field containing a grouping identifier, a field containing a cluster identifier, and at least one other field containing other information pertaining to an approximately-matched data object.

When clusters and/or groupings are stored in the form of records in a table structure, the table may be modified by the addition of subsequently-determined clusters and groupings, or by the removal of previously-stored clusters or groupings that have been determined to be erroneous. Modification may include, for example, loading the table, generating a new record (e.g., a new row), and entering data into fields of new records. Alternatively, modification may include deleting previously-entered records and/or deleting data in fields of those records. Modification may be done automatically or by manual input.

### F. Primary Identifiers in Groupings

FIG. 5 further illustrates another example aspect of the invention: primary identifiers. In various example embodiments, a grouping may include one or more primary identifiers. A primary identifier is a basis for indicating particular relevance among one or more clusters and/or unclustered data objects included in a grouping. The relevance indicated by primary identifier may be useful when providing match data to a data consumer or when storing matches.

Table 2 shows a tabular representation of how primary identifiers are used to indicate one or more particularly relevant clusters from among all of the clusters within grouping 500 of FIG. 5. Referring that figure, the grouping 500 includes three primary identifiers 561, 562, and 563. These primary identifiers are languages, specifically, English, Spanish, and French, as shown in the “Primary Identifier” column of Table 2. As discussed above, the grouping 500 is an approximate match of clusters of database records that relate to the movie Star Wars. However, only some of the clusters describe the original Star Wars; other clusters describe Star Wars: Special Edition. In grouping 500, it has been determined that those clusters describing the original movie are primary clusters. That is, these clusters have particular relevance to the grouping. Moreover, because there are several clusters that describe Star Wars but vary by language, the primary identifier data elements include a language description, as shown in the “Primary Identifier” column. This table thus provides a listing of each “primary cluster” in the grouping 500.

TABLE 2

| Grouping | Primary | Cluster |
|---|---|---|
| Identifier | Identifier | Identifier |
| 99 | English | 001 |
| 99 | Spanish | 002 |
| 99 | French | 005 |

In practice, whether a cluster is a “primary cluster,” e.g., whether it has been assigned a primary identifier, may be based on the algorithms and/or predetermined rules of an enterprise. The assignment of one or more primary identifiers may be performed after matching of data objects into clusters and matching of clusters and data objects into groupings during a data matching procedure. Assignments may also be made to clusters and groupings previously stored, and assignments also may be made during manual processing of stored match data.

### VI. Integrating Media Content Databases

### A. An Example Application for Clustering

One application of clusters and/or groupings provides a way to integrate databases that are generated by, or originate from, different data providers, e.g., businesses, enterprises, companies, governmental bodies, and individuals. In example embodiments, procedures for determining clusters and groupings, such as those described above, can be used to integrate databases of media content originating from or generated by different providers. A user, such as any provider, enterprise, third party, etc., that may use, purchase, or sell databases or repackage and/or reformat databases for use, may wish to integrate such databases of media content. This is because individual providers each may store their data in different ways and/or in different or proprietary data structures.

As one example, movie database providers may each store records containing metadata, such as content information such as title, length, format, plot summary, director, producer, etc., for the same movies. However, each database provider may use differently-titled field headings for the data. Accordingly, in order to search the records in each database by a particular type of metadata, such as by title, by director, etc., a user may need to access that metadata under different field headings in each database. For example, to search records by title, in one database the user may have to search in the fields under “Program.Master_title” for a specific movie, while in another database the user may need to search in the fields under “Video.Title,” while in yet another database the user may need to search under both “Bundle.Name” and “Title.Name.”

Differences among how various databases store and label data present a problem for a user who wishes to quickly search among the information stored in the multiple databases and/or efficiently present that information to others. The complexity of the problem increases as the number of providers and/or databases increases.

Moreover, a correlation and/or correspondence between records having content information in one database and records in another database may not be recognized by algorithms and other procedures used to search such data. As one example, a movie title stored in a title field of a record in one database may not match a movie title stored in a title field of a record in another database, even though the respective records in which those titles are stored are records storing content information of the same movie. For example, a movie title may be misspelled (e.g. “StarWars” instead of “Star Wars”). As another example, a movie title may be open to various spellings (e.g. one database may store the number two in a title as “2” while another may store it as “Two”; one title may be in the language of the movie's home country while the another title is translated from that language; or both titles may be translated into a language that spells a foreign word in multiple ways). Accordingly, an algorithm or procedure that directly compares the two records, e.g., a text matching algorithm, may not determine that, despite the difference of information in the respective title fields, the records contain the same content information, and thus the records describe the same movie. What is needed is a way to match records in media content databases despite differences in the data and in the way that data is stored.

In example embodiments directed to integrating media content databases, procedures for determining clusters and groupings can be used to integrate data from such databases. In these embodiments, data objects that are matched by a clustering (or grouping) procedure include individual records stored in the media content databases, e.g., records containing metadata such as content information for a particular song, video, movie, television show, broadcast, etc. Similarly, attributes that are compared or otherwise used during the clustering procedure (e.g., when generating a preliminary list, when establishing candidate lists, when identifying clusters, or determining clusters) include, for example, metadata (including field headers and content information in the form of field data).

As an example, where the content information stored in a particular database relates to songs, such as a database where the records contain information about songs, field headers may be “Song Title,” “Artist,” “Year,” “Album,” “Track Number,” “Genre,” and so forth. In practice, however, particular field headers are specific to each database and generally are in a computer-readable, provider-specific, and/or proprietary format (e.g., “Song.Title” or “Trk_No”). Accordingly, a clustering procedure may be configured to recognize among different field headers. Such configuration may be made, for example, in the predetermined rules of the clustering procedure. Configuring the predetermined rules for the clustering procedure in this way may include manual entry of field header information for each media content database, automatic determination of field header information by appropriate logic or procedure, or loading of field header information provided by a media content database provider and/or a third party.

Attributes compared or used during a clustering procedure include metadata such as content information in the form of field data of a particular record. Following the example field headers discussed above, field data for a record, as stored in one database, may be, for example, “Wherever I May Roam,” “Metallica,” “1991,” “Metallica,” “5 of 12,” and “Heavy Metal.” However, field data for a record of the same song information, as stored in another database, may be “Wherever_I_May_Roam” (a simplified computer-readable format) “Metalica” (a misspelling of the artist name), “1991,” “The Black Album” (an alternative album name), “5” (omitting the total number of tracks), and “Rock” (a broader genre). Accordingly, a clustering procedure is configured to recognize the match between the two records despite differences in the fields of the records. The clustering procedure may be configured in such a manner, for example, by using fuzzy matching, predetermined rules, and so forth, as discussed herein.

### B. An Example Application for Grouping

Records from various media content databases can be matched by using a procedure for clustering. However, as discussed herein, clustering procedures determine exact matches among data objects such as records. On the other hand, approximate matches between records from various media content databases may be determined by a grouping procedure. Determining such approximate matches may improve integration of media content databases.

In an example embodiment, grouping records from media content databases includes determining approximate matches between clusters of records and/or unmatched records (e.g., unclustered records). A grouping procedure makes such determination by using metadata (including field headers and field data from the records). Example grouping procedures are similar to procedures for clustering database records that were described above.

### C. Media Content Databases and Media Content

Databases of media content can include databases of programs, recordings, and other types of media including, without limitation, music albums, television shows, movies, games, videos, and broadcasts of various types. The databases may contain metadata (and content data, in some instances) directed only to a single type of media content, such as a database of movies, a database of music albums, or directed to multiple types of media content. Similarly, the data stored in a database may be multimedia. In this instance, fields of the database may consist of or contain one or more of text, graphics, photographic images, video clips, audio clips, hyperlinks, program code, and the like.

Generally, information is stored in media content databases in any suitable format, e.g., hierarchical database, a network database, a relational database, an object database, and so forth. In an example embodiment, a media content database is a relational database in which information is stored in the form of records. For example, a media content database may be a relational database that can be described as tables consisting of a heading row and multiple data rows (e.g., records). Each record includes one or more data elements (e.g., fields). The heading contains attributes (e.g., field headers), such that there is an attribute for each field in a record. Each field header identifies information stored in the corresponding field of the records. In a media content database, information stored in the fields of the records (e.g., metadata) includes content identifiers, user identifiers, and device identifiers.

A content identifier is metadata directly pertaining media content. In an example database that stores records of television shows, content identifiers may include show title, original air date, creator, theme song, etc. On the other hand, in an example database that stores records of movies, content identifiers may include title, release date, director, producer, etc. Generally, examples of record fields discussed above in connection with FIG. 5 and Table 1 have been content identifiers.

Content identifiers may also include provider numbers. A provider number is data, such as a numeric value or alphanumeric string, that a provider includes with records in the provider's media content database, such that each record has a unique and/or arbitrary provider number. For example, the “Record Number” column in Table 1 lists the provider numbers of the database records listed in that table. Each provider number is an example of a content identifier.

A user identifier is metadata about one or more users of a media content database. The user identifier may identify or relate to a user that has used the database in the past or is currently using it. For example, a user identifier may include a creator of a record (e.g., a media content database provider) and a current user of a record (e.g., a user performing integration of various media content databases). User identifiers also may include, for example, user access history information, such as creation date or modification date, and user access privileges, such as read only, read and write, or write only.

A device identifier is metadata about an input or output device. The device identifier may relate to a device from which media content information originates (e.g., a computer on which a record was generated, or a Blu-Ray DVD player on which a user has entered a command requesting media and/or media content information) or a destination for media content information (e.g., a Blu-Ray DVD player to which data stored in a cluster or data stored in a grouping is being sent in response to a command) Device identifiers may contain hardware information such as model numbers, hardware configurations (e.g., processor speed, RAM capacity, EPROM/ROM versions, and hard drive space), firmware information such as version number or update time, software information such as version number, and/or network information such as IP address and MAC address. For example, a device identifier may be used to determine whether media content described by a record is suitable for a particular device. If, for example, a record describes streaming media, the record may include a device identifier that contains information relating to the minimum requirements required by destination hardware requesting such streaming media.

### D. Content Warehouses of Media Content Databases

In various example embodiments, multiple media content databases are stored in a federated data system such as a content warehouse. A content warehouse is a data management system that allows access to (and output from) multiple sources of data. The content warehouse may include media content databases generated, stored, or maintained by an enterprise that integrates media content, as well as third-party media content databases stored internally within or external to a system operated by the enterprise.

As discussed below, a content warehouse may include one or more consolidated data structures. A consolidated data structure is a data structure used by a content warehouse to provide data, such as records and metadata, to a matching system in the form of a single data structure. A consolidated data structure may enable (or improve) the flow of data to and from the content warehouse by making uniform the presentation of data from the content warehouse.

Generally, a media content database provider chooses a data structure for storing metadata and other content information in its database. This data structure may be thought of as the native data structure of the database. For example, one music database provider may choose as its native data structure a particular table structure containing certain metadata (e.g., title, album, release year, duration (in seconds), and genre), while another provider may choose as its native data structure a different table structure containing different metadata (e.g., title, album, duration (in minutes:seconds), and track number). Accordingly, when various databases from multiple providers are included in a content warehouse, the content warehouse can consist of metadata in multiple native data structures. Metadata provided by the content warehouse thus will have differing data structures depending on which databases are accessed. This may complicate the presentation of data, e.g., the loading of metadata at a content matching system and any matching procedures performed on the metadata.

Moreover, even where various media content database providers use the same native data structure, the providers may use the data structure in different ways. For example, various television program database providers may store their metadata in a database record that includes a program name field. One provider may include only program name information (e.g., “Seinfeld”) in that field. Another provider, however, may include in the program name field the program name information as well as the season name (e.g., “Seinfeld/Season 7”), while another provider may include program name information and an episode title (e.g., “Seinfeld/The Maestro”). Thus, even when the data structures among the databases are the same, metadata may be stored in different ways. This may complicate transforming metadata from a native data structure (e.g., a database record) because knowledge of the fields of the record may not be equivalent to (or sufficient to deduce) knowledge of the metadata stored in those fields.

### E. Consolidated Data Structures

In example embodiments, a content warehouse uses a consolidated data structure to present metadata from all database providers in a single data structure. Native data structures are transformed into the consolidated data structure by a data importing procedure that loads metadata from the native data structure and transforms it into the consolidated data structure.

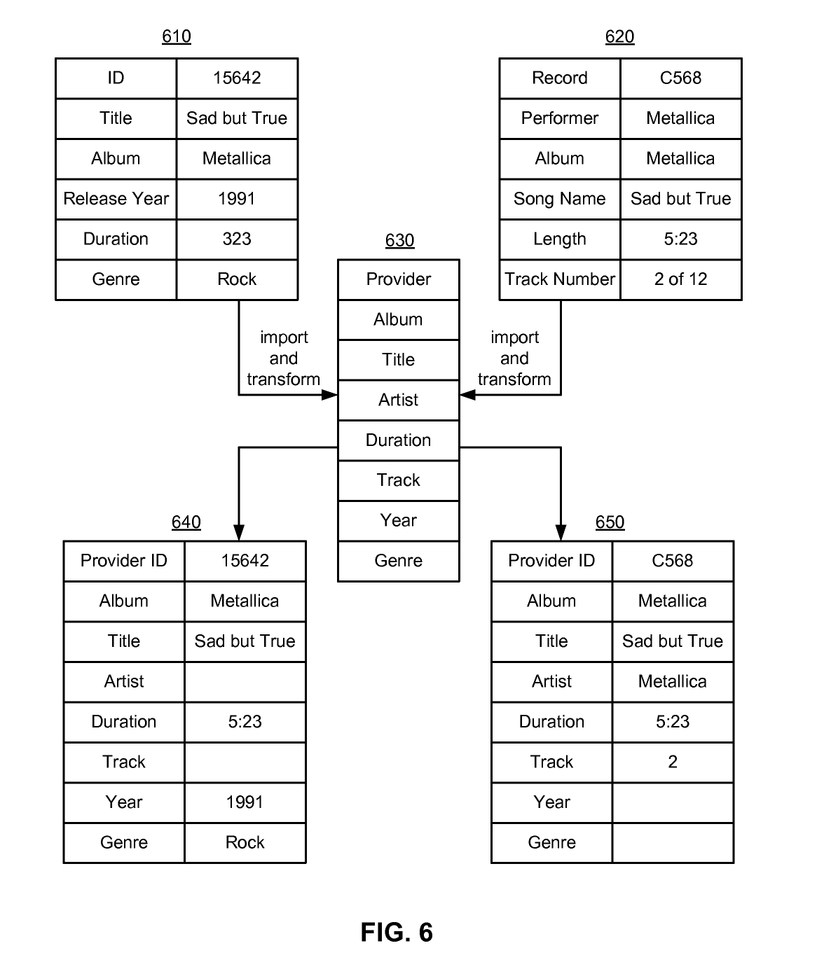

FIG. 6 illustrates how metadata may be imported and transformed from a native data structure into an example consolidated data structure. Database record 610 is a native data structure for metadata of a song in one music database, and database record 620 is another native data structure for metadata of the same song in another music database. As shown in the figure, the native data structure for the music database which stores the database record 610 is a table having field headings “ID,” “title,” “album,” “release year,” “duration” (in seconds), and “genre,” and content information for those headings. Similarly, the native data structure for the music database which stores the database record 620 is a table having field headings “record,” “performer,” “album,” “song name,” “length” (in minutes:seconds), and “track number,” and content information for those headings. Field headings “ID” and “record” indicate the unique identifier assigned by the database provider to the respective database records.

Consolidated record 630 is a consolidated data structure that may be used by a content warehouse when providing metadata from the two music databases. The consolidated record 630 is a table having field headings “provider ID,” “album,” “title,” “artist,” “duration,” “track,” “year,” and “genre.” As described below, the consolidated record 630 is a data structure that is able to store any metadata contained in either of the native data structures illustrated in FIG. 6.

The importation and transformation of metadata from a native data structure into a consolidated data structure is illustrated by the arrows in FIG. 6. Metadata (e.g., the database record 610 or the database record 620) is imported from its native data structure. Importation may include parsing the metadata, e.g., separating out the individual data elements from the record. Parsed metadata (e.g., individual data elements such as field information, as well as strings, characters, etc. taken from an individual field) may be more suitable for transformation into a consolidated data structure than complete metadata (e.g., a database record).

The imported metadata is then transformed. Transformation includes rearranging field information from the native data structure into corresponding fields of the consolidated data structure 630. For example, information from the “title” field of database record 610 is placed into the “title” field of the consolidated data structure 630. Corresponding fields need not have the same field headings. For example, information from the “performer” field of the database record 620 is placed into the “artist” field of the consolidated data structure 630. Where the native structure lacks a field that is included in the consolidated data structure 630 (e.g., the database record 610 lacks an “artist” field), that field may be left blank in the consolidated data structure.

Transformation may include modification and/or conversion of the parsed metadata. Examples of this are shown in the consolidated records 640 and 650. In the consolidated record 640, the duration information from the native structure has been converted to “5:23,” which is another format for the “323” seconds stored in the database record 610. As another example, in the consolidated record 650, the track number has been modified from “2 of 12” in the database record 620 to “2.”

As a result of importation and transformation, consolidated records of the metadata are generated. This is shown by the consolidated record 640 (which corresponds to database record 610) and the consolidated record 650 (which corresponds to the database record 620). These consolidated records may be output and/or stored by the content warehouse.

In some example embodiments, the importing and transforming of metadata as shown in FIG. 6 may be performed independent of any other operations or procedures involving the content warehouse. In these embodiments, consolidated metadata (such as the consolidated record 640 and the consolidated record 650) may be stored in the content warehouse for later use by, for example, a matching procedure. In other example embodiments, however, the importing and transforming of metadata may be performed in real-time, e.g., metadata from a native data structure may be transformed into a consolidated structure when that metadata is requested, or is sent to, a matching system. In these embodiments, consolidated metadata may not be stored.

The particular data structure is the consolidated data structure may be chosen arbitrarily by the enterprise generating the content warehouse, or by a third party data consumer of the enterprise. On the other hand, it may be determined (in whole or in part) by the native data structures used by the various databases included in the content warehouse. For example, if one of the individual databases has as its native structure a table structure that includes metadata fields common to all of the other databases, then that native structure may be chosen as the consolidated data structure. As another example, the consolidated data structure may be generated by an aggregate of all of the data structures stored in the various databases of a content warehouse. An example of this is shown in FIG. 6, in which the consolidated data structure 630 is a database record that contains the aggregate of the fields which make up the native data structures (the database records 620 and 630).

### F. Example Procedures for Integrating Media Content Databases

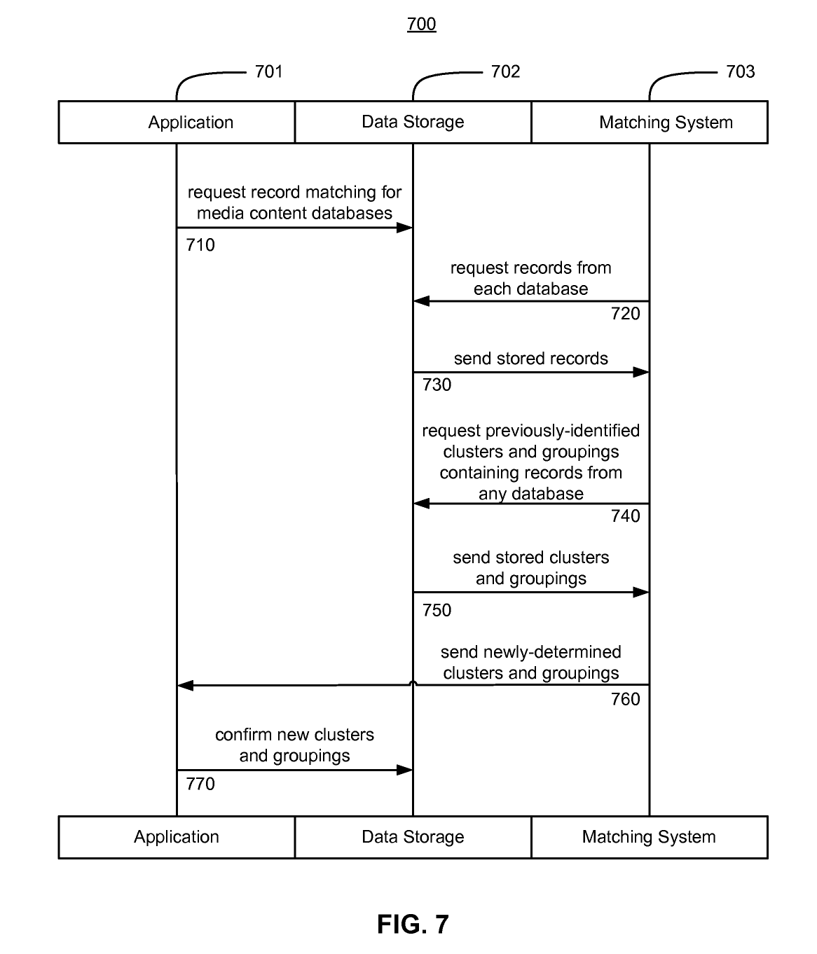

FIG. 7 shows a ladder diagram 700 of an example procedure for integrating media content databases. The procedure may be carried out by a system that includes an application component 701, data storage 702, and matching system 703. Generally, the system is controlled by the application component 701. For example, the application component 701 may initiate, control, and/or configure various aspects of a procedure for integrating media content databases (e.g., the rungs of ladder diagram 700).

The application component 701 may include, for example, user interfaces and client devices through which a user may control or operate functions performed by the application component 701. The application component 701 also may include automated procedures, e.g., programs that operate the system and/or data integration procedures continuously or at regular intervals.

Data stored in the data storage 702 includes various media content databases. Each databases contains data (e.g., records containing media content information such as content identifier, user identifiers, and/or device identifiers) for integration by the system. Data stored by the data storage 702 may be stored in a local storage component (e.g., a server, a hard drive, RAID, hard drives, optical drives, tape drives, magneto-optical drives, and the like) or in one or more remote storage components (e.g., a network-accessible storage device and IP-based storage schemes).

The data storage 702 also may include match data, e.g., clusters and groupings. As discussed above, match data may be generated in order to record matches (and approximate matches) among data objects. In accordance with the example procedures discussed in connection with FIG. 7, match data may be generated to record matches between records in various media content databases.

Data storage 702 may include (or be accessible as) a federated data system such as a content warehouse. For example, the data storage 702 may send data, and/or provide access to data, in a common format and/or data structure.

The matching system 703 may include, for example, hardware, firmware, and/or software configured to determine matches among data, e.g., records originating from various media content databases. The matching system 703 further may include a component configured for data storage (e.g., a hard drive or RAM) onto which data (e.g., databases, records, and fields) may be received and from which data may be sent. For example, the matching system 703 may load received data into a memory cache and also may output data from the cache. In this manner, hardware, firmware, and/or software of the matching system 703 may operate on data (e.g., records, databases, clusters, and groupings) received from other components such as, for example, the data storage 702.

While the system of FIG. 7 is illustrated by three components, this configuration is simply for illustrative purposes, and in practice the system may have additional (or fewer) components. For example, the application component may include several devices (e.g., multiple user interfaces and/or multiple client devices), each of which is configured to access the system. On the other hand, the application component 701, the data storage 702, and the matching system 703 may reside in the same physical location (e.g., a computer or a server).

At rung 710, the application component 701 sends a request to the matching system 703. The request initiates a procedure for matching records stored in various media content databases. The request may be a general request that matches be determined from among data stored in any or all databases stored by the system (e.g., in the data storage 702) or otherwise accessible by the system. Alternatively, the request may identify specific databases for matching. The request is sent to the matching system 703.

The request at rung 710 further may specify records for matching. For example, the request may specify records according to data (e.g., records that have certain field data at a particular field header), type of media content (e.g., records relating to songs, records relating to movies, records relating to television shows, records relating to streaming content, and so forth), or match status (e.g., records previously unmatched to other records, records previously only approximately matched to other records, or records previously matched to other records).

After the request is sent from the application component 701, the matching system 703 requests records from the various media content databases at rung 720. In accordance with the request, databases requested by the matching system 703 may be all databases stored by the data storage 702 or it may be particular databases identified for matching.

The data storage component 702 sends the requested records at rung 730. The records may be sent as individual records (e.g., a single row of a relational database, with or without field headers), as multiple records (e.g., a table including of multiple records), or as a database in whole or in part. Accordingly, the data storage component 702 may parse, transform, or otherwise modify databases and/or records prior to sending the requested information.

At rung 740 the matching system 703 requests stored match data (e.g., stored clusters and/or groupings) from the data storage component. The matching system 703 may perform rung 740 simultaneously with, or prior to, rung 730. For example, if the matching system 703 is able to initiate a request for match data prior to initiating a request for records, the request for match data may be made first. This may occur when, for example, a determination of which records are to be requested requires more time to make than a determination of which match data is to be requested.

Match data requested by the matching system 703 may be related to records that are requested at rung 720. For example, requested match data may be limited to match data that includes one or more records requested for matching. However, match data requested at rung 740 need not be related to any of the records requested for matching (e.g., none of the requested records are included in the match data). This may be the case where, for example, all of the records included in the requested match data originate from media content databases that have been integrated previously.

Matching system 703 may be configured to determine what match data is to be requested at rung 740. For example, matching system 703 may establish or format the request at rung 740 without input or instruction from application component 701. The determination of suitable match data may be made, for example, according to predetermined rules or other enterprise-defined logic stored in and/or accessed by matching system 703.

Alternatively, the request at rung 740 may be determined, in whole or in part, by information received from application component 701. For example, match data may be identified by the record matching request sent by the application component 701 at rung 710.

At rung 750, the data storage component 702 sends to the matching system 703 the match data which was requested at rung 740. The data storage component 702 may perform rung 750 simultaneously (or prior to) rung 730. For example, if the matching system 703 requests match data prior to requesting records, data storage component 702 may respond first to the prior request.

Although not illustrated in FIG. 7, the matching system 703 is configured to match records sent by data storage 702. Thus, once records are sent, the matching system 703 may make determinations of matches (e.g. determinations of clusters and determinations of groupings). These determinations may be made according to procedures that have been discussed herein, such as the procedures discussed in connection with FIGS. 1, 2, 3, and 4.

At rung 760, the matching system 703 sends clusters (e.g., matches between records) and/or groupings (e.g., approximate matches between records and/or clusters) that have been determined to the application component 701. By sending matches to the application component 701, matches determined by the matching system 703 can be confirmed by the application component 701. For example, a user can view matched records via the application component 701 and confirm that such records are matches. Alternatively, matching system 703 may send determined clusters and/or groupings directly to the data storage 702 for storage. (This is not illustrated in FIG. 7.)

At rung 780, application component 701 confirms matched records to the data storage component 702. Confirmation of a match may include, for example, verifying that records match (or approximately match), editing an approximate match to be an exact match, or editing a determined approximate match to be an exact match. In this manner, data storage 702 may store matches that have been verified by the application component 701, which may increase the accuracy of matches stored by data storage 702.

### G. A Procedure for Matching Metadata

A data matching procedure is used to match, for example, content information stored in various databases. In an example embodiment, that content information is metadata relating to content data.

The various content databases may include, for example, databases that originate from or are stored by the enterprise matching the data (e.g., an internal database) and databases that originate from or are stored by third parties (e.g., an external, or third party, database). The databases may be consolidated into a content warehouse, e.g., the databases may be linked, unified, or otherwise accessible together.

The procedure proceeds by providing metadata from the databases (e.g., from the content warehouse) to a matching system. The matching system then parses the metadata into data elements. For example, metadata for a particular television program can be stored in the form of a database record. The record can include the name of the program, its release year, and the duration of the program, and each of these items are stored as individual data elements. Parsing the metadata thus separates out the individual data elements from the record. Parsed data (e.g., individual data elements) may provide a more suitable input for a matching system than complete metadata (e.g., a database record).

The procedure continues by matching the metadata (which may or may not be parsed) from the various databases. Suitable procedures for determining matches between metadata include any of those discussed above in connection with FIGS. 1, 2, 3, 4, and 5. For example, matching may include preliminary matching (e.g., fuzzy matching of title, duration, release year, and artist data elements that have been parsed from content metadata, followed by candidate list matching, cluster identification, and cluster determination.

Predetermined rules may be used in the matching of metadata. As discussed herein, predetermined rules may be used when establishing and redistributing candidate lists, and when determining matches. In the context of a content matching procedure, two movie databases may each contain metadata for a particular movie that includes film duration. However, one movie database may store film duration in minutes, while the other movies database stores it in seconds. A direct comparison of the metadata from the two movie databases thus may not be informative because the values for duration may be much different. For example, if a particular movie is exactly two hours in length, in the one database, a duration field in the metadata for that movie may contain a value of “120,” but in the other database, a duration field in the metadata may contain “7200.” On the other hand, a predetermined rule may be used which recognizes that metadata in the first database includes duration fields that have values stored in minutes, and that metadata in the other database includes duration fields that have values stored in seconds. This predetermined rule may then be applied, for example, when making candidate lists in order to more accurately find matches between fields of the metadata.

### VI. System Architecture

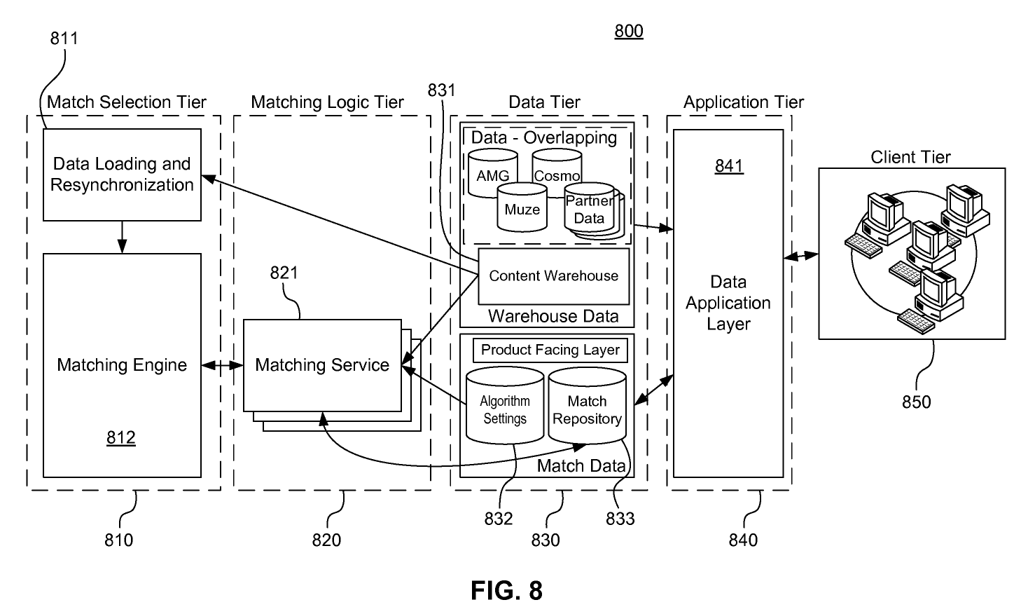

FIG. 8 illustrates an example of a data matching system 800 that operates in accordance with some of the example embodiments of the invention. The data matching system 800 may be configured to perform data matching procedures including, for example, the procedure illustrated in FIG. 1 and the cluster matching procedure described above. Generally, an enterprise may use the matching system to receive data from internal and/or external sources and to determine correlations between object elements contained in the data. These correlations may be recorded and stored as clusters and groupings, which are retrieved in one form or another by various system components, by the enterprise itself, and/or by data consumers. FIG. 8 illustrates the system as being divided into five tiers. It is illustrated in this manner merely to aid in describing various functions that the system may perform; the divisions should not be construed as limiting the input, output, configuration, or function of any component of system 800.

Data accessed or utilized by the system 800 is stored or otherwise accessible via a data tier 830. The data tier 830 includes a content warehouse 831, which is similar to a federated data store, which is data management system that allows access to several data sources, e.g., datasets and databases. The content warehouse 831 may include datasets generated, stored, or maintained by the enterprise which operates or controls system 800, as well as third-party data stored internally within or external to the system. As shown in FIG. 8, data may flow directly or indirectly from the content warehouse 831 to the other tiers of the system.

Part of a data matching procedure may be performed at a match selection tier 810. This tier contains a data loading and resynchronization component 811 and a matching engine 812. The matching engine 812 is a component that may be used to produce preliminary match lists of data objects and/or clusters. The data loading component 811 serves several functions. It may run data loading and data resynchronizing procedures for the matching engine 812 and may update a memory cache of the matching engine with new data, deleted data, and changes to data objects. The data loading component 811 and the matching engine 812 may operate continuously, on demand, or at regular intervals, as determined by enterprise needs and resources. In this manner, a matching logic tier 820 may retrieve preliminary match lists from the match selection tier 810. Accordingly, the match selection tier 810 may be configured to perform some of the functions described above in connection with block 102 of FIG. 1.

The matching logic tier 820 includes a continuous matching service 821. The matching service 821 is an automated component, like the match selection tier 810, that may operate continuously, on demand, or at regular intervals. The matching service 821 evaluates unmatched data objects and matched data objects that belong to pre-existing clusters and groupings to determine any unrecorded matches between data objects. Accordingly, the matching logic service 820 may be configured to perform some of the functions described above in connection with blocks 102, 104, 106, and 108 of FIG. 1.

The data tier 830 interacts with the matching logic tier 820 in various ways. The matching service 821 receives data objects for evaluation from the content warehouse 831. Settings related to the operation of the matching service 821, such as predetermined rules used to identify or determine matches, are stored at and retrieved from an algorithm settings component 832 in the data tier 830. Matches determined by the matching service 821, both as clusters and as groupings, are retrieved by a match repository 833 in the data tier 830 for storage as clusters and groupings. Similarly, the matching service 821 retrieves pre-existing clusters and groupings from the match repository 833. In this manner, the matching service 821 may evaluate prior matches by comparison to match data retrieved from the matching engine 812.

Application tier 840 includes a data application layer 841 through which a client tier 850 may interact with, control, and manage the data matching system 800. The client tier 850 is an access point into the system 800 for the enterprise and data consumers. The application tier 840 includes a user interface to facilitate such access. The user interface permits the management of match information, which includes the capability to review and modify stored matches. The user interface further includes a reporting component that permits the client tier 850 to access and receive reports relating to the system 800. And perhaps most importantly, the user interface allows the client tier 850 to access and use all data stored at the data tier 830, including data stored in content warehouse 831, clusters, and groupings.

### XII. Computer Readable Medium Implementation

The example embodiments described above such as, for example, the systems and procedures depicted in or discussed in connection with FIGS. 1, 2, 3, 4, 5, 6, 7, and 8, or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general purpose digital computers or similar devices.

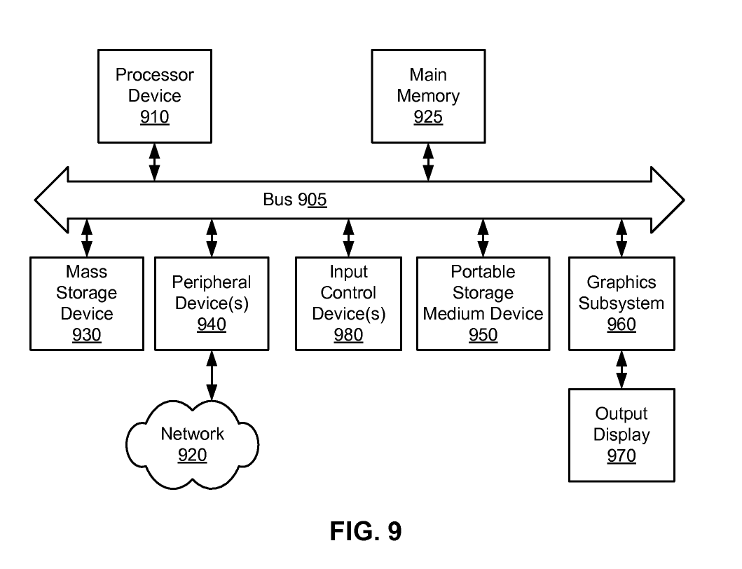

FIG. 9 is a block diagram of a general and/or special purpose computer 900, in accordance with some of the example embodiments of the invention. The computer 900 may be, for example, a user device, a user computer, a client computer and/or a server computer, among other things.

The computer 900 may include without limitation a processor device 910, a main memory 925, and an interconnect bus 905. The processor device 910 may include without limitation a single microprocessor, or may include a plurality of microprocessors for configuring the computer 900 as a multi-processor system. The main memory 925 stores, among other things, instructions and/or data for execution by the processor device 910. The main memory 925 may include banks of dynamic random access memory (DRAM), as well as cache memory.

The computer 900 may further include a mass storage device 930, peripheral device(s) 940, portable storage medium device(s) 950, input control device(s) 980, a graphics subsystem 960, and/or an output display 970. For explanatory purposes, all components in the computer 900 are shown in FIG. 9 as being coupled via the bus 905. However, the computer 900 is not so limited. Devices of the computer 900 may be coupled via one or more data transport means. For example, the processor device 910 and/or the main memory 925 may be coupled via a local microprocessor bus. The mass storage device 930, peripheral device(s) 940, portable storage medium device(s) 950, and/or graphics subsystem 960 may be coupled via one or more input/output (I/O) buses. The mass storage device 930 may be a nonvolatile storage device for storing data and/or instructions for use by the processor device 910. The mass storage device 930 may be implemented, for example, with a magnetic disk drive or an optical disk drive. In a software embodiment, the mass storage device 930 is configured for loading contents of the mass storage device 930 into the main memory 925.

The portable storage medium device 950 operates in conjunction with a nonvolatile portable storage medium, such as, for example, a compact disc read only memory (CD-ROM), to input and output data and code to and from the computer 900. In some embodiments, the software for storing an internal identifier in metadata may be stored on a portable storage medium, and may be inputted into the computer 900 via the portable storage medium device 950. The peripheral device(s) 940 may include any type of computer support device, such as, for example, an input/output (I/O) interface configured to add additional functionality to the computer 900. For example, the peripheral device(s) 940 may include a network interface card for interfacing the computer 900 with a network 920.

The input control device(s) 980 provide a portion of the user interface for a user of the computer 900. The input control device(s) 980 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information, the computer 900 may include the graphics subsystem 960 and the output display 970. The output display 970 may include a cathode ray tube (CRT) display and/or a liquid crystal display (LCD). The graphics subsystem 960 receives textual and graphical information, and processes the information for output to the output display 970.

Each component of the computer 900 may represent a broad category of a computer component of a general and/or special purpose computer. Components of the computer 900 are not limited to the specific implementations provided here.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized (and navigated) in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method for integrating media content databases, comprising:
receiving first metadata from a record stored in a first media content database;
receiving second metadata from a record stored in a second media content database;
comparing a field of the first metadata to a field of the second metadata, the field of the first metadata and the field of the second metadata both containing media content information;
determining that the media content information of the field of the first metadata contains information relating to the media content information of the field of the second metadata;
generating an alphanumeric string and a data structure;
assigning the alphanumeric string to the first metadata by storing in the data structure the alphanumeric string and a field of the record stored in the first media content database; and
assigning the alphanumeric string to the second metadata by storing in the data structure the alphanumeric string and a field of the record stored in the second media content database.

2. The method of claim 1,
wherein the media content information of the field of the first metadata and the media information of the field of the second metadata both are one of a content identifier, a user identifier, and a device identifier.

3. The method according to claim 2, further comprising:
determining a likelihood that the media content information of the field of the first metadata relates to the media content information of the field of the second metadata,
wherein the media content information of the field of the first metadata and the media content information of the field of the second metadata both are content identifiers,
wherein the determining the likelihood step is performed prior to the comparing step, and
wherein the likelihood is based on a numeric weight.

4. The method according to claim 3, further comprising:
determining a second likelihood that the media content information of the field of the first metadata relates to the media content information of the field of the second metadata,
wherein the determining the second likelihood step includes applying predetermined rules to at least one of the numeric weight, the media content information of the field of the first metadata, and the media content information of the field of the second metadata,
wherein the determining the second likelihood step is performed after the determining the first likelihood step.

5. The method according to claim 1,
wherein the data structure is a pre-existing data structure,
wherein the generating of the alphanumeric string and the data structure is performed prior to the comparing step.

6. The method according to claim 5,
wherein the data structure is a table structure, and
wherein the field of the record stored in the first media content database and the field of the record stored in the second media content database both are content identifiers.

7. The method according to claim 1, further comprising:
comparing the media content information of the field of the first metadata to media information of a field of third metadata,
determining that the first metadata is a candidate match to the third metadata based on the comparing of the media content information of the fields of the first and third metadata; and
storing data corresponding to the candidate match.

8. The method according to claim 7, further comprising:
retrieving the data corresponding to the candidate match;
comparing media content information of a field of the first metadata and media content information of a field of the third metadata after retrieving the data corresponding to the candidate match; and
determining that first metadata is a match to the third metadata after retrieving the data corresponding to the candidate match.

9. A non-transitory computer-readable medium storing instructions which, when executed by a processor, cause the processor to perform:
receiving first metadata from a record stored in a first media content database;
receiving second metadata from a record stored in a second media content database;
comparing a field of the first metadata to a field of the second metadata, the field of the first metadata and the field of the second metadata both containing media content information;
determining that the media content information of the field of the first metadata contains information relating to the media content information of the field of the second metadata;
generating an alphanumeric string and a data structure;
assigning the alphanumeric string to the first metadata by storing in the data structure the alphanumeric string and a field of the record stored in the first media content database; and
assigning the alphanumeric string to the second metadata by storing in the data structure the alphanumeric string and a field of the record stored in the second media content database.

10. The non-transitory computer-readable medium according to claim 9,
wherein the media content information of the field of the first metadata and the media information of the field of the second metadata both are one of a content identifier, a user identifier, and a device identifier.

11. The non-transitory computer-readable medium according to claim 10, the instructions further comprising:
determining a likelihood that the media content information of the field of the first metadata relates to the media content information of the field of the second metadata,
wherein the media content information of the field of the first metadata and the media content information of the field of the second metadata both are content identifiers,
wherein the determining the likelihood step is performed prior to the comparing step, and
wherein the likelihood is based on a numeric weight.

12. The non-transitory computer-readable medium according to claim 9, the instructions further comprising:
determining a second likelihood that the media content information of the field of the first metadata relates to the media content information of the field of the second metadata,
wherein the determining the second likelihood step includes applying predetermined rules to at least one of the numeric weight, the media content information of the field of the first metadata, and the media content information of the field of the second metadata,
wherein the determining the second likelihood step is performed after the determining the first likelihood step.

13. The non-transitory computer-readable medium according to claim 9,
wherein the data structure is a pre-existing data structure,
wherein the generating of the alphanumeric string and the data structure is performed prior to the comparing step.

14. The non-transitory computer-readable medium according to claim 13,
wherein the data structure is a table structure, and
wherein the field of the record stored in the first media content database and the field of the record stored in the second media content database both are content identifiers.

15. The non-transitory computer-readable medium according to claim 9, the instructions further comprising:
comparing the media content information of the field of the first metadata to media information of a field of third metadata,
determining that the first metadata is a candidate match to the third metadata based on the comparing of the media content information of the fields of the first and third metadata; and
storing data corresponding to the candidate match.

16. The non-transitory computer-readable medium according to claim 15, further comprising:
retrieving the data corresponding to the candidate match;
comparing media content information of a field of the first metadata and media content information of a field of the third metadata after retrieving the data corresponding to the candidate match; and
determining that first metadata is a match to the third metadata after retrieving the data corresponding to the candidate match.

17. A system for integrating media content databases, comprising:
a matching component configured to compare metadata from two records, determine whether the two records are a match based on the comparison, and assign an alphanumeric string to the two records; and
a data storage component configured to store media content databases, send metadata from records stored in the media content databases to the matching component, and store, in a data structure separate from the media content databases, the alphanumeric string and a field of each of the two records,
wherein each of the two records is stored in a different media content database.

18. The system according to claim 17,
wherein the data storage component stores the media content databases in a content warehouse, and
wherein the data storage component sends metadata in a consolidated data structure.

19. The system according to claim 17,
wherein the data storage component is further configured to send match data to the matching component, and
wherein the matching component determines whether the two records are a match further based on the match data.

20. The system according to claim 17, further comprising:
an interface configured to allow a user to retrieve information from the matching component and the data storage component, and allow the matching component and the data storage component to retrieve user input.
